(19) United States
(12) Patent Application Publication
(10) Pub. No.: US 2007/0078637 A1
(43) Pub. Date: Apr. 5, 2007

(54) METHOD OF ANALYZING OIL AND GAS PRODUCTION PROJECT

(75) Inventors: Alex G. Martin, Katy, TX (US); David R. Eifert, Webster, TX (US); David B. Kimble, Katy, TX (US)

Correspondence Address: WONG, CABELLO, LUTSCH, RUTHERFORD & BRUCCULERI,;L.L.P., 20333 SH 249, SUITE 600, HOUSTON, TX, 77070, US

(73) Assignee: BERWANGER, INC., Houston, TX (US)

(21) Appl. No.: 11/162,994

(22) Filed: Sep. 30, 2005

(51) Int. Cl. G06G 7/48

(52) U.S. Cl. 703/6

(57) ABSTRACT

A method is disclosed for analyzing an oil and gas production project with a computer system. Using a computer program, a user inputs characteristics of systems for the project and inputs characteristics of the expected production of the project, such as production life (years) and the production rate of the project. Based on the characteristics, the program generates a plurality of projected case profiles, each of which defines characteristics of the systems for a period of the production life of the project. A controlling case is then created using information from the plurality of case profiles. In the controlling case, each of the systems is analyzed to determine in which profile the system has the greatest cost, weight, area, or other criterion. From the analysis, characteristics of the systems are generated for the project that best meet the expected production over the entire production life of the project.

### FIELD OF THE PRESENT DISCLOSURE

The subject matter of the present disclosure generally relates to a method of analyzing an oil and gas production project and more particularly relates to an oil and gas management program for designing a production project and analyzing equipment requirements, costs, and other information associated with the project.

### BACKGROUND OF THE PRESENT DISCLOSURE

Designers of oil and gas production projects must use and analyze a great deal of information. To assist the designer, analysis programs known in the art enable a user to model the facilities and production systems of the project, input information relevant to the oil and gas production, perform calculations, and produce various estimates and other results.

In FIG. 1, components of a prior art analysis program 10 are schematically illustrated. The analysis program 10 includes user interfaces 20, databases 22, a simulator 24, and a reporting tool 26. With the user interfaces 20, the user builds a model of the project, defines characteristics of those modeled facilities and production systems of the project, and defines characteristics of the production for the project. For example, the user interfaces 20 include a field layout interface 40 and definition interfaces 50. The user first accesses the field layout interface 40, such as shown in FIG. 2, and defines characteristics of the intended field or reservoir (e.g., U.S. Gulf of Mexico) 42 of the project. Then, the user builds a model 44 of the project by graphically arranging various facilities 46 and interconnecting them with pipelines 47. Typical facilities include, but are not limited to, offshore wellhead platforms, offshore processing platforms, subsea wells/manifolds, offshore offloading buoys and floating storage vessels, and onshore gathering and processing facilities.

Each facility 46 of the model 44 has various systems, equipment, and substructures associated with it. Such systems, equipment, and substructures for oil and gas production are known in the art. For example, some systems for oil and gas production include separation systems, crude metering and export pump systems, gas compression systems, gas dehydration systems, gas sweetening systems, hydrocarbon dew point control systems, condensate disposal systems, produced water treatment systems, relief systems, water injection systems, power systems, heating and cooling medium systems, raw water systems, fire protection systems, drilling systems, accommodations, and structural steel.

When building the model 44 of the project, the user also accesses definition interfaces 50, such as the one shown in FIG. 2, to input information or characteristics pertaining to the facilities 46, the pipelines 47, and the production of the project. One skilled in the art will appreciate what information would be relevant for the definition interfaces 50, so the present disclosure does not describe such details at length. In general, however, the information includes the type of production (e.g., conventional crude), the production rates, the seawater depth, the number of production wells, whether there will be separation on the facility, the sizing of a facility, the pressure and temperature levels, the composition of the reservoir fluid, and any other information related to the production and the facilities that would go into the initial design of the project.

As discussed previously, the prior art analysis program 10 also has databases 22, the simulator 24 and the reporting tool 26. The databases 22 store information on the various facilities, systems, equipment, costs, etc. for oil and gas production. The simulator 24 performs process calculations, utility consumption calculations, equipment sizing and cost calculations, substructure sizing and cost calculations, and pipeline sizing and cost calculations. The calculations performed by the simulator 24 use the information entered in the user interfaces 20 and stored in the databases 22 to produce a plurality of parametric studies 30 of the project. From the parametric studies 30, the reporting tool 26 produces various reports for the user to review the design of the project. To produce the parametric studies 30, the program 10 allows the user to select one parameter, such as sea depth, production rate, etc. Then, using a plurality of increments of the selected parameter in a given range, the simulator 24 produces the plurality of parametric studies 30 where each study 30 has information calculated with one of the increments of the selected parameter. Based on the parametric studies 30, the user can then review the resulting changes to the facilities and assess the design of the project.

Although the prior art analysis program 10 discussed above has proven effective in designing and analyzing production projects, what is needed is a program that can further compile information and produce more effective estimates to design and analyze a production project. The subject matter of the present disclosure is directed to overcoming, or at least reducing the effects of, one or more of the problems set forth above.

### SUMMARY OF THE DISCLOSURE

A method is disclosed for analyzing an oil and gas production project with a computer system. Using a computer program, a user builds a model of the facilities for the project and inputs information of the production systems for the facilities. Examples of facilities include offshore wellhead platforms, offshore processing platforms, subsea wells/manifolds, offshore offloading buoys and floating storage vessels, and onshore gathering and processing facilities. The facilities have various systems, such as separation systems, crude metering and export pump systems, gas compression systems, gas dehydration systems, gas sweetening systems, hydrocarbon dew point control systems, condensate disposal systems, produced water treatment systems, relief systems, water injection systems, power systems, heating and cooling medium systems, raw water systems, fire protection systems, drilling systems, accommodations, and structural steel In addition, the user inputs information pertaining to the production associated with the project. For example, the production information includes the production life (years) and the production rate of the project. Based on the defined information, the program calculates characteristics of each production system in a plurality of periods (years) of the production life and generates a plurality of project profiles for the project. Each of the project profiles defines characteristics of the production systems for a period (e.g., year) of the production life of the project. A controlling case is then created using information from project profiles. In the controlling case, each production system for the project in the selected profiles is analyzed according to at least one criterion, such as the weight, the cost, the capacity, the area, the size of equipment, etc. From the analysis, a controlling case is created that includes characteristics of the production systems for the project that meet at least one criterion over all of the production periods of the selected profiles. For example, characteristics for each of the systems are selected based on which project profile has the greatest or the least weight, cost, capacity, or area for that system among all other project profiles for that system. The program then recalculates characteristics of the project based on the controlling case.

The foregoing summary is not intended to summarize each potential embodiment or every aspect of the present disclosure.

### BRIEF DESCRIPTION OF THE DRAWINGS

The foregoing summary, preferred embodiments, and other aspects of the subject matter of the present disclosure will be best understood with reference to a detailed description of specific embodiments, which follows, when read in conjunction with the accompanying drawings, in which:

FIG. 1 shows a schematic diagram of an analysis program for an oil and gas production project according to the prior art.

FIG. 2 shows interfaces for the prior art analysis program of FIG. 1.

FIG. 3 shows a schematic diagram of an analysis program for an oil and gas production project according to certain teachings of the present disclosure.

FIG. 4 shows the analysis program of FIG. 3 in more detail.

FIG. 5 shows an input worksheet of the analysis program of FIG. 4.

FIG. 6 shows a facility worksheet of the analysis program of FIG. 4.

FIG. 7 shows a program interface for creating a controlling case for the project.

FIG. 8 shows a program interface for selecting project profiles from which to build the controlling case.

FIG. 9 shows a program interface for determining controlling characteristics for each system from the selected project profiles.

FIG. 10 shows a program interface for determining controlling characteristics for each pipeline of the project from the selected project profiles.

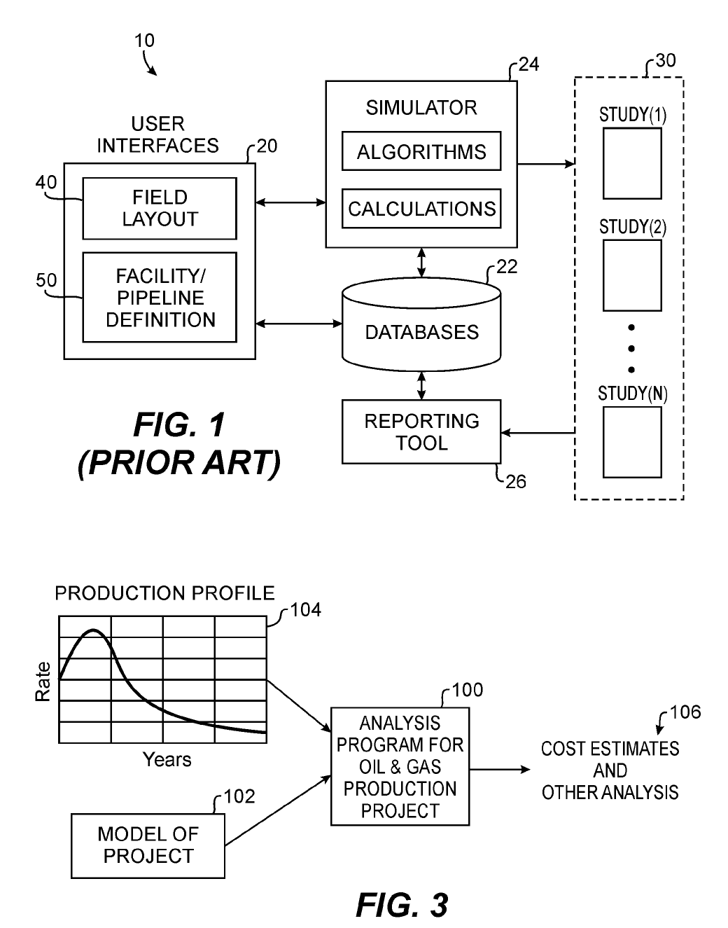

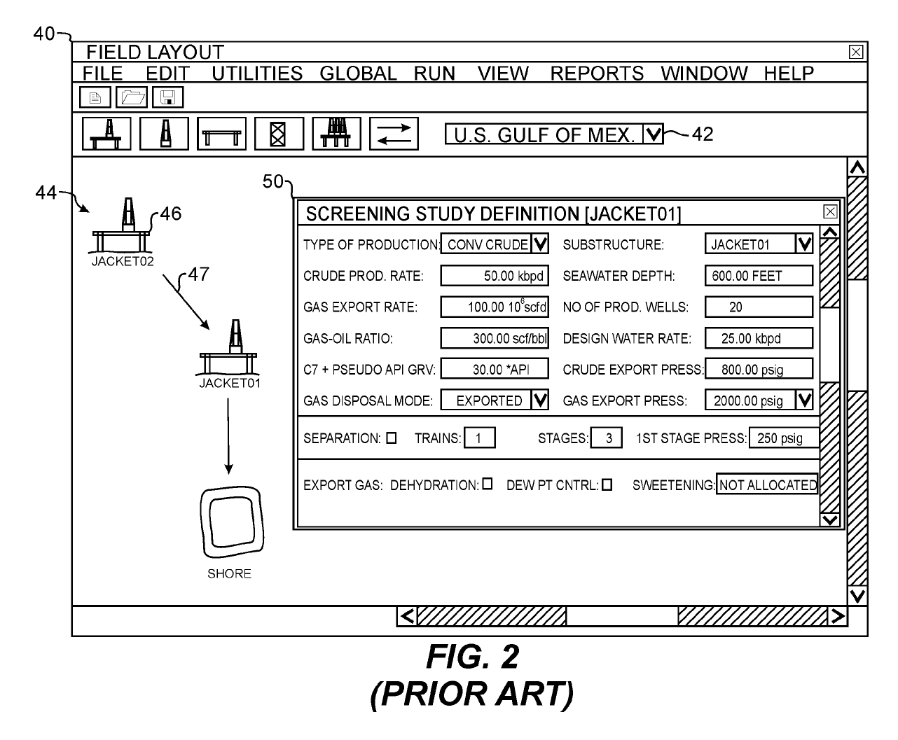

While the subject matter of the present disclosure is susceptible to various modifications and alternative forms, specific embodiments thereof have been shown by way of example in the drawings and are herein described in detail. The figures and written description are not intended to limit the scope of the inventive concepts in any manner. Rather, the figures and written description are provided to illustrate the inventive concepts to a person skilled in the art by reference to particular embodiments, as required by 35 U.S.C. §112.

### DETAILED DESCRIPTION

In FIG. 3, the overall scheme of an analysis program 100 according to certain teachings of the present disclosure is illustrated. Using the program 100, a user builds a model 102 of the project and inputs information pertaining to the production profile 104 of the project. In general, the model 102 has information on various facilities, pipelines, and production systems of the project. The production profile 104 estimates how oil and gas production is expected to flow throughout the life of the project. From the model 102 and the production profile 104, the program 100 produces cost estimates and other relevant analysis 106 for the user. The objective of the analysis program 100 is to estimate an overall capital cost to exploit a particular production field of the project. Thus, the results 106 correlate the expected production of the project with an overall estimate of the capital expenditure for the project

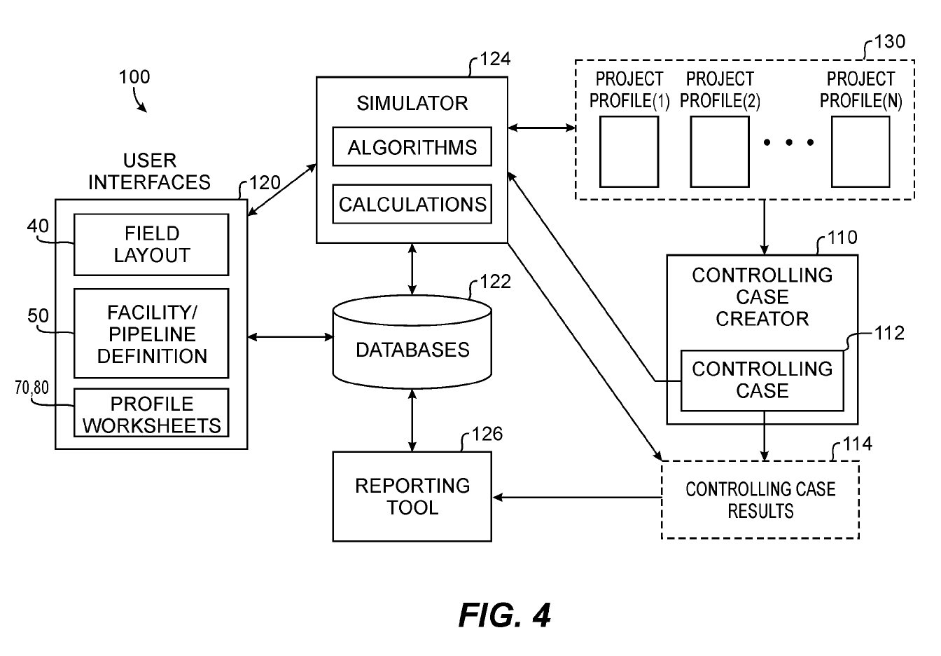

In FIG. 4, components of the analysis program 100 of FIG. 3 are illustrated in more detail. As with the prior art program discussed in the Background Section of the present disclosure, this analysis program 100 is also used to design an oil and gas production project. The analysis program 100 includes a user interfaces 20 (i.e., field layout interface 40 and definition interfaces 50), databases 122, simulator 124, and reporting tool 126, each of which is similar to those components described above. In addition to these previously described components, the analysis program 100 includes worksheets 70 and 80 for defining the production profile of the project and facilities. Furthermore, the analysis program 100 includes a controlling case creator 110, which assists the user in reviewing, processing, and assessing the information available from multiple project profiles 130 generated with the simulator 124. As explained in more detail below, the controlling case creator 110 generates a controlling case 112 from the plurality of project profiles 130 and provides further analysis of the project so that the project may best meet the overall project objectives. In other words, the controlling case 112 provides a comprehensive overview of the production systems of the project that best meet the needs of the production over the production life of the project.

The initial operation of the analysis program 100 is similar to the prior art program discussed previously in the Background Section of the present disclosure. For example, the user interfaces 120 (e.g., field layout interface 40 and description interfaces 50) are used to build a model of the project and define characteristics of the facilities and systems.

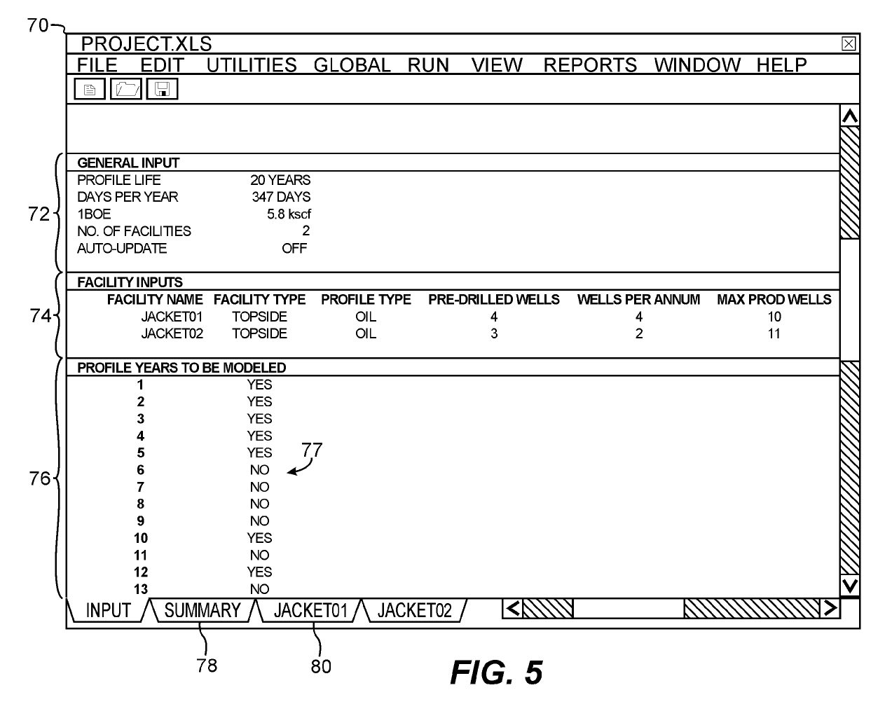

Once the user has modeled the project and defined its characteristics, the program 100 develops one or more templates for the user to define production profiles for the project and each facility. The user then enters production data to define the production profiles using the worksheets 70 and 80 of the user interfaces 20 of FIG. 4. For example, an input worksheet 70, such as shown in FIG. 5, allows the user to input information in general inputs fields 72, facility input fields 74, and profile fields 76. The general input fields 72 specify the intended production life or period of production for the project, the number of production days per year, the Barrels of Oil Equivalent (BOE), and the number of facilities in the project.

In the facility input fields 74, each of the facilities for the project is listed with corresponding information, such as the type of facility, its name, the type of production (e.g., oil) handled, how many pre-drilled wells the facility has, the number of wells to be added per year, the maximum number of production wells for the facility over the production life, etc. In the profile fields 76, each year of the profile life is listed along with an indication 77 whether that year has been selected to be modeled when generating a plurality of project profiles (130; FIG. 4) discussed in more detail below.

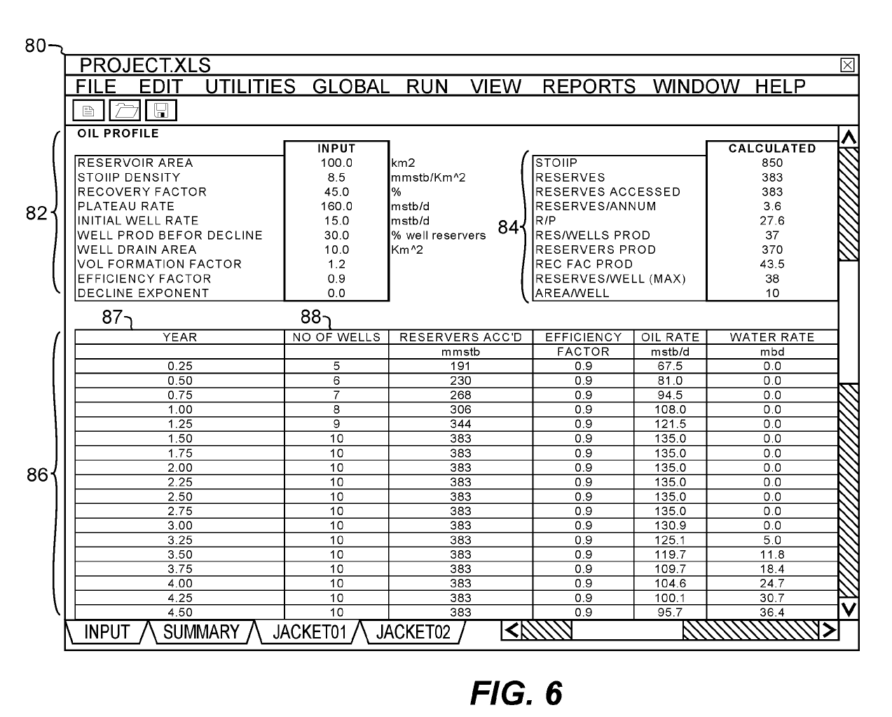

As seen at the bottom of the worksheet 70, a summary worksheet at tab 78 is also provided for the user to view the overall production profile for the project. Furthermore, each facility of the project is given a facility worksheet 80 for the user to enter data pertaining to the indicated facility, its production capabilities, and its production profile. For example, the facility worksheet 80 shown in FIG. 6 defines the production profile for the selected facility “JACKET01.” In the worksheet 80, the user inputs characteristic values 82 of the production for the facility. The worksheet 80 then calculates calculated values 84 of the facility's production and displays information in a spreadsheet 86 representing the production profile for the selected facility. The production profile in spreadsheet 86 is divided into a plurality of production periods 87, which are given in quarter of a year increments in this example. For each production period 87, the spreadsheet 86 lists information 88 previously defined by the user and calculated by the program, such as the number of wells, the reserves accessed, the efficiency factor, the oil rate, the water rate, etc. for each production period 87.

Once the user is satisfied that the production profiles of the project and facilities conform to the project objectives, the user returns to the input worksheet 70 of FIG. 5 and selects “YES” in the indications 77 for those profile years 76 the user wants the program to model. Some of the profile years 76 may not significantly add to the analysis of the project so that the user may elect not to model those years. In addition, the user may choose not to model certain years to conserve processing time.

Once the user has selected the years 76 to be modeled, the user runs the simulator 124 of the program 100 in FIG. 4. In response, the simulator 124 uses various algorithms and calculations and produces the plurality of project profiles or snapshots 130 of the project, as already described briefly above. To produce the profiles 130, the simulator 124 performs process simulations using the system and production information from the selected model years. The algorithms and calculations are known in the art and are not described in detail. In general, the algorithms and calculations involve performing process calculations; determining utility balances; calculating the weight, area, and cost of equipment systems; calculating the size and cost of pipelines; and calculating the size and cost of facility substructures (e.g., the size, costs, transportation, and construction of substructures for the facilities).

Each of the project profiles 130 includes information about the facilities, systems, equipment, substructures, pipelines, etc. that meets the production for one of the modeled years (76; FIG. 5) selected from the production life. As will be appreciated in the art, the rates of production and the characteristics of what is produced from a reservoir will change from year-to-year over the production life of the project. Concurrently, the systems and equipment needed to meet such changes in production will also change from year-to-year. Thus, each project profile 130 provides an independent snapshot of the system and equipment requirements needed to meet the production rates and characteristics for a particular modeled year of the production life. Using the reporting tool 126, the user can produce various reports from the project profiles 130. In general, the reports show capital expenditures, system costs, equipment sizing, pipelines, CO₂ emissions, energy balances, and other reports having information related to the design of the project.

Then, the user accesses the simulator 124 and generates the plurality of snapshots or project profiles 130. Each project profile 130 provides an independent snapshot of the production systems needed to meet the production profile in a particular modeled year of the production life of the project. Once the project profiles 130 have been generated, the user accesses the controlling case creator 110, which provides additional analysis of the project. In particular, the controlling case creator 100 analyzes information from selected project profiles 130 based on one or more criteria and generates the controlling case 112. Then, information from the controlling case 112 is input into the simulator 124 again to produce recalculated results 114 for the controlling case 112. Finally, the reporting tool 126 of the program 100 can compile reports based on the calculated results 114 produced with the controlling case 112. While the project profiles 130 are intended to provide independent snapshots of the project, the calculated results 114 obtained with the controlling case 112 provide information of the project (e.g., equipment costs, size, capacity, area, substructure, etc.) that will best meet the production profile over several modeled years of the project.

Now that a general description of the analysis program 100 has been discussed, additional details of the controlling case creator 110 and the controlling case 112 are discussed below.

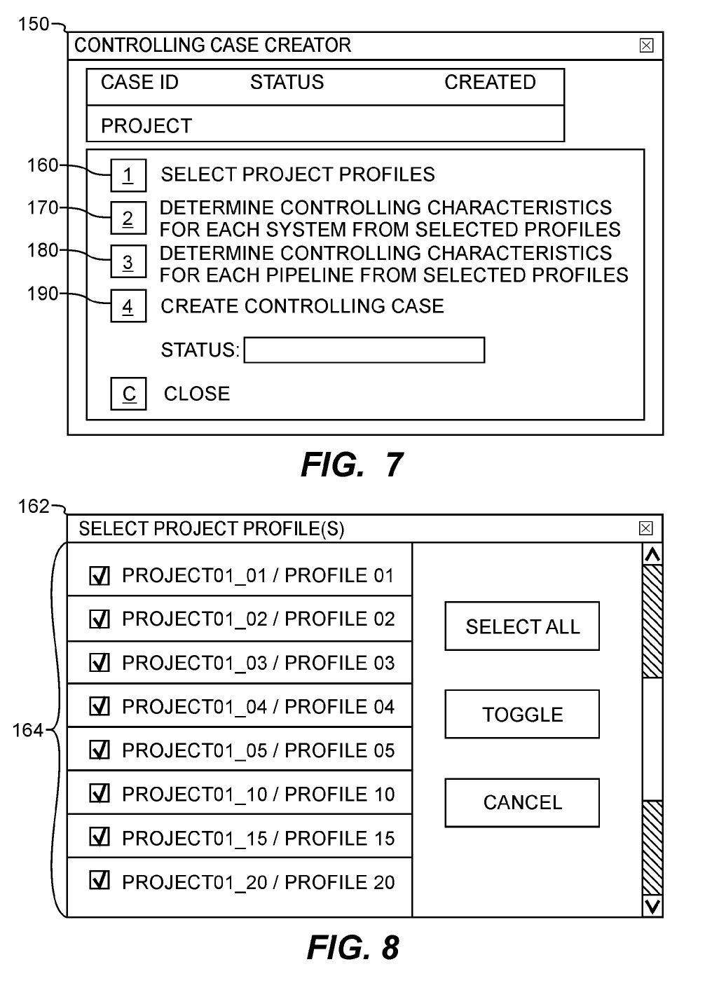

Once the simulator 124 has created the project profiles 130 as explained previously, the user accesses a menu interface 150 of the analysis program shown in FIG. 7. The menu interface 150 provides consecutive operations 160, 170, 180, and 190 for creating the controlling case of the project. The operations include “(1) Select Project profiles” 160, “(2) Determine Controlling Characteristics of Each Production System from Selected Project profiles” 170, “(3) Determine Controlling Characteristics of Each Pipeline from Selected Project profiles” 180, and “(4) Create Controlling Case from the Determined Characteristics” 190.

To begin creating the controlling case 112, the user selects the first operation 160, “(1) Select Project profiles,” which brings the user to a selection interface 162 shown in FIG. 8. This interface 162 lists all of the available project profiles 164, which correspond to the project profiles (130; FIG. 4) previously generated with the simulator (124; FIG. 4). As noted above, the project profiles 164 represent analysis of the project (e.g., facilities, systems, substructures, pipelines, etc.) for particular years of the production of the project that have been modeled and run through various algorithms and calculations of the simulator (124; FIG. 4). Accordingly, each project profile 164 has varied and comprehensive information associated with the facilities, systems, pipelines, substructures, and other aspects of the project in a particular period (i.e., annually of the production.

In the selection interface 162, the user selects which project profiles 164 to consider when generating the controlling case. Under the default, all project profiles 164 are chosen for consideration, but the user can manually select which project profiles 164 to use. For example, some of the project profiles 164 may not significantly add to the analysis of the project, or the user may wish to conserve processing time.

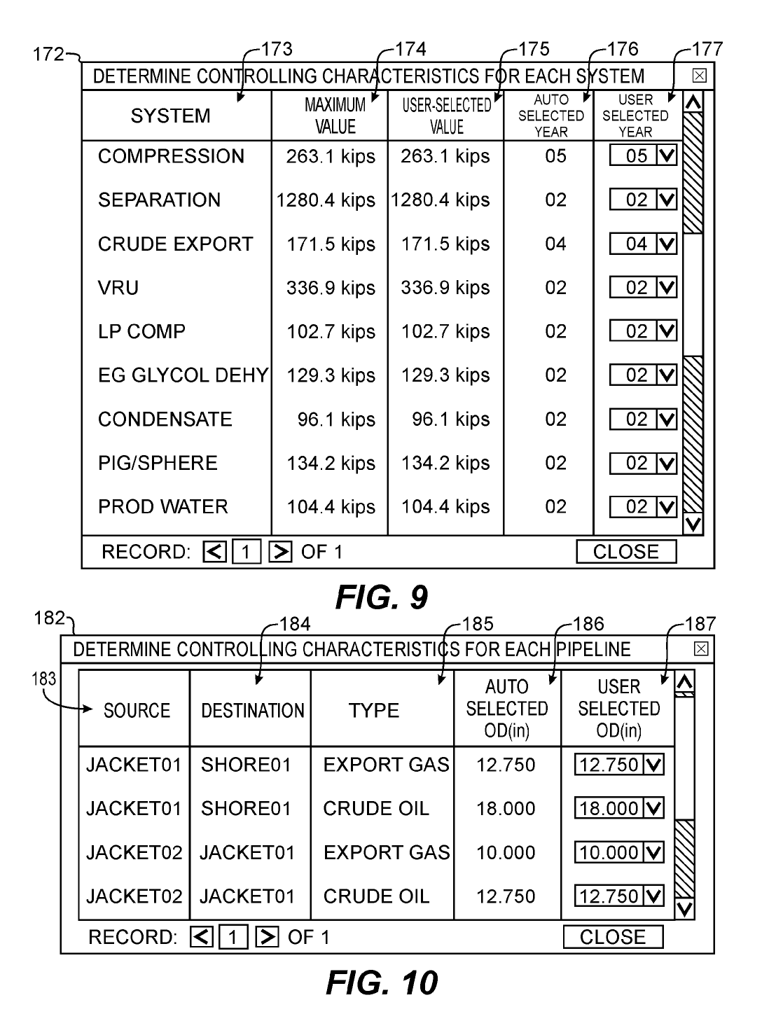

Once the project profiles 164 have been selected, the user proceeds to the second operation 170 in the menu interface 150 of FIG. 7 to determine controlling characteristics for each system of the project from the selected project profiles. In response, the user is brought to an interface 172 shown in FIG. 9, which lists each system 173 of the project. In displaying the various systems 173, processing of some of the information in the selected project profiles (130; FIG. 4) has occurred to show in interface 172 the maximum system resources needed in any particular year. Through such processing, the totality of the information in the selected project profiles 130 is minimized to display in interface 172 only that which may be considered crucial to deployment of the system, i.e., to generating the controlling case.

Specifically, for each system 173, a controlling profile period or year 176 has been automatically selected from the available project profiles based on a value 174 for the systems 173. In the present example, the automatically selected values 174 represent the greatest physical weights (e.g., kips) for the corresponding systems 173 in the available project profiles. This is a logical choice for automatic selection because those profile years 176 will typically represent the greatest capital expenditure for the particular systems 173 of the project. Thus, designing to meet those system requirements in those profile years 176 will best meet the production over the life of the project. Consequently, selection of such maximum years 176 is suitable for building a controlling case representing maximum requirements for the project to meet anticipated production goals.

By way of example, the compression required during later production years could be higher than earlier years. Thus, those project profiles (130; FIG. 4) generated by the simulator (124; FIG. 4) for the earlier production years may indicate that facilities of the project require only a modest amount of compression. However, later in the production life of the project, more and more compression may be needed, which equates to a need for more and more compressor equipment, utilities, structural support, and associated aspects of the project. At some point (i.e., year) in the production (i.e., during one of the project profiles), a maximum amount of compression is specified. The requirement for the compression system in this profile year will govern the compression requirements over the production life of the project. Consequently, using the maximum requirement for the compression system along with all the other systems in the controlling case 112 may produce a comprehensive, controlling overview of the entire project.

The selection of the value or weight in the interface 172 can be based on those profile years 176 where the corresponding system 173 has the heaviest “dry” or operational weight of all other available profile years. The heaviest weight of the production system 173 may equate to the most costly system equipment, the greatest area required for that system equipment on a production platform or the like, and/or the most top-side structural support for that production system. Although the selections to populate interface 172 are based on the maximum weight in the present example, the selections can be based on other characteristics of the production systems. For example, the selections can be based on the cost or capital expenditure associated with the production system 173, based on the area required by the production system 173, based on the production or operational capacity provided by the system 173, or based on other distinguishing characteristics of the production systems. Moreover, the selections can be based on the lesser or least of these characteristics.

Regardless of the criteria used for automatic selection in the population of interface 172, the user can override the automatic selection by entering a user-selected year 177. The program then displays the corresponding user-selected value 175 associated with the selected year 177. This user-selected value 175 is contrasted with the auto-selected value 174 to enable the user to make design decisions based on the comparisons. In most cases, the user may not need to adjust the automatic selection, but the user may wish to account for certain contingencies, situations, goals, or other user-defined criteria when designing the project.

In the present example, the analyzed characteristic (i.e., the value or weight of the production systems) and the controlling criterion (i.e., the greatest characteristic in the selected profiles) are predefined in the program, but the characteristics and criterion may be user-selected or user-defined in other embodiments of the program. In addition, even though the determinations for all of the productions systems in the present example are based on the same controlling characteristic and criterion (i.e., the greatest value), the determinations for each system in other embodiments of the program can be performed with more than one controlling characteristic and criteria, and the determinations for each system can use different characteristics and criteria than those used for other systems.

Once the controlling characteristics of the systems have been determined, the user proceeds to the third operation 180 in interface 150 of FIG. 7 to determine controlling characteristics for each pipeline from the selected project profiles. In response, the user accesses interface 182 shown in FIG. 10. Although the pipelines are provided separate from the production systems in this interface 182, it is possible to organize the pipelines as one of the production systems within the previous interface 172 of FIG. 9.

In the interface 182, each pipeline of the project is listed with its source 183, its destination 184, its type 185, and an automatically selected variable 186, which is an outside diameter (OD) in the present example. For example, a first pipeline of the project is indicated as an export gas pipeline 185 having JACKET01 as its source 183 and SHORE01 as its destination 184. The program has automatically calculated the variable 186 to be 12.750-inches for the maximum outside diameter of this pipeline to meet the production requirements over the available profile years of the project. In fields 187, the user can change the automatically selected variable for each pipeline as desired. In the present example, the maximum outside diameter of the pipeline is used for the variable 186 because it essentially equates to the most costly pipeline for the project. However, other controlling characteristics for the pipelines can include value, cost, length, weight, or any other distinguishing characteristic of the pipelines. In addition, other controlling criteria can include the greater of these, the lesser of these, or any other criteria to distinguish characteristics of the pipelines.

Once the user has made the determinations in the interfaces of FIGS. 7 through 10, the user has defined controlling characteristics of the production systems and pipelines for the controlling case (112; FIG. 4) of the project. To finally analyze the controlling case (112; FIG. 4), the user selects operation 190 in the menu interface 150 of FIG. 7. In response, the program 100 in FIG. 4 reruns the simulator 124 with the project information associated with the controlling case 112 to produce a controlling profile or results 114 for the project. For example, the simulator 124 will recalculate structural and substructure sizing and costs to support the area and weight requirements associated with the controlling case 112

After the simulator 124 performs its calculations, the results 114 from the controlling case 112 include project information on the systems, substructures, pipelines, costs, and other aspects of the project needed to meet the defined production over the production life of the project. The results 114 produced by the simulator 124 are more comprehensive than what is alone contained in the controlling case 112, because the amount of substructures required, the overall construction costs, utility balances, and calculations of other features are impacted by the project information associated with the controlling case 112. Furthermore, depending on the selections and determinations made with the controlling case creator 110, the results 114 produced can represent a “maximum” implementation if the automatic “maximum” selections by the program 100 have been used. Alternatively, the results 114 produced can represent a “user-defined” implementation if the user has altered some of the automatic selections of the program 100.

With the results 114 calculated, the user is able to access the reporting tool 126 to produce all the same reports detailed earlier. For example, the reporting tool 126 can create a cost estimate report that encompasses the overall cost for implementing the systems, facilities, and other requirements based on the results 114 from the controlling case 112 developed with the program 100. In addition, the user can view comparison reports that compare any single project profile 130 with the results 114 from the controlling case 112.

The foregoing description of preferred and other embodiments is not intended to limit or restrict the scope or applicability of the inventive concepts conceived of by the Applicants. In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

What is claimed is:

1. A computer-implemented method of analyzing an oil and gas production project, comprising:
creating a model of systems and pipelines for the project;
creating a plurality of profiles from the model, each profile containing system requirements and pipeline requirements to meet a given period of production for the project;
selecting at least two of the profiles;
selecting one of the system requirements from the at least two profiles;
selecting one of the pipeline requirements from the at least two profiles; and
creating a controlling case for the project based on the selected system requirements and the selected pipeline requirements.

2. The method of claim 1, wherein the systems are selected from the group consisting of: separation systems, crude metering and export pump systems, gas compression systems, gas dehydration systems, gas sweetening systems, hydrocarbon dew point control systems, condensate disposal systems, produced water treatment systems, relief systems, water injection systems, power systems, heating and cooling medium, systems, raw water systems, fire protection systems, drilling systems, accommodations, and structural steel.

3. The method of claim 1, wherein the system requirements are selected from the group consisting of process calculations, utility balances, system equipment, system capacity, system weight, system area, system cost, substructure size, and substructure cost.

4. The method of claim 1, wherein the pipeline requirements are selected from the group consisting of diameter, cost, length, and type of pipeline.

5. The method of claim 1, wherein selecting one of the system requirements from the at least two profiles comprises selecting a weight for a given system in one of the profiles that is greater or lesser than the weight for the same system in the other profiles.

6. The method of claim 1, wherein selecting one of the system requirements from the at least two profiles comprises selecting a cost for a given system in one of the profiles that is greater or lesser than the cost for the same system in the other profiles.

7. The method of claim 1, wherein selecting one of the system requirements from the at least two profiles comprises selecting a capacity for a given system in one of the profiles that is greater or lesser than the capacity for the same system in the other profiles.

8. The method of claim 1, wherein selecting one of the system requirements from the at least two profiles comprises selecting an area for a given system in one of the profiles that is greater or lesser than the area for the same system in the other profiles.

9. The method of claim 1, wherein selecting one of the system requirements from the at least two profiles comprises:
automatically comparing the system requirements for a given system in each of the at least two profiles; and
automatically selecting one of the system requirements for the given system based on the comparison.

10. The method of claim 1, wherein selecting one of the pipeline requirements from the at least two profiles comprises selecting a diameter, a cost, a length, or a type for a given pipeline in one of the profiles that is greater or lesser than that for the same pipeline in the other profiles.

11. The method of claim 1, wherein creating the plurality of profiles from the model comprises performing process simulations using information pertaining to the systems, the pipelines, and the production to determine the system requirements and the pipeline requirements for the profiles.

12. The method of claim 1, further comprising calculating controlling requirements for the systems and the pipelines of the project using information associated with the controlling case.

13. The method of claim 12, wherein calculating controlling requirements for the systems and the pipelines of the project using information associated with the controlling case comprises recalculating structural requirements to support area and weight requirements associated with the controlling case.

14. A computer-readable device having program instructions for performing a computer-implemented method of analyzing an oil and gas production project, the method comprising:
creating a model of systems and pipelines for the project;
creating a plurality of profiles from the model, each profile containing system requirements and pipeline requirements to meet a given period of production for the project;
selecting at least two of the profiles;
selecting one of the system requirements from the at least two profiles;
selecting one of the pipeline requirements from the at least two profiles; and
creating a controlling case for the project based on the selected system requirements and the selected pipeline requirements.

15. The computer-readable device of claim 14, wherein the systems are selected from the group consisting of: separation systems, crude metering and export pump systems, gas compression systems, gas dehydration systems, gas sweetening systems, hydrocarbon dew point control systems, condensate disposal systems, produced water treatment systems, relief systems, water injection systems, power systems, heating and cooling medium, systems, raw water systems, fire protection systems, drilling systems, accommodations, and structural steel.

16. The computer-readable device of claim 14, wherein the system requirements are selected from the group consisting of process calculations, utility balances, system equipment, system capacity, system weight, system area, system cost, substructure size, and substructure cost.

17. The computer-readable device of claim 14, wherein the pipeline requirements are selected from the group consisting of diameter, cost, length, and type of pipeline.

18. The computer-readable device of claim 14, wherein selecting one of the system requirements from the at least two profiles comprises selecting a weight for a given system in one of the profiles that is greater or lesser than the weight for the same system in the other profiles.

19. The computer-readable device of claim 14, wherein selecting one of the system requirements from the at least two profiles comprises selecting a cost for a given system in one of the profiles that is greater or lesser than the cost for the same system in the other profiles.

20. The computer-readable device of claim 14, wherein selecting one of the system requirements from the at least two profiles comprises selecting a capacity for a given system in one of the profiles that is greater or lesser than the capacity for the same system in the other profiles.

21. The computer-readable device of claim 14, wherein selecting one of the system requirements from the at least two profiles comprises selecting an area for a given system in one of the profiles that is greater or lesser than the area for the same system in the other profiles.

22. The computer-readable device of claim 14, wherein selecting one of the system requirements from the at least two profiles comprises:
automatically comparing the system requirements for a given system in each of the at least two profiles; and
automatically selecting one of the system requirements for the given system based on the comparison.

23. The computer-readable device of claim 14, wherein selecting one of the pipeline requirements from the at least two profiles comprises selecting a diameter, a cost, a length, or a type for a given pipeline in one of the profiles that is greater or lesser than that for the same pipeline in the other profiles.

24. The computer-readable device of claim 14, wherein creating the plurality of profiles from the model comprises performing process simulations using information pertaining to the systems, the pipelines, and the production to determine the system requirements and the pipeline requirements for the profiles.

25. The computer-readable device of claim 14, wherein the method further comprises calculating controlling requirements for the systems and the pipelines of the project using information associated with the controlling case.

26. The computer-readable device of claim 25, wherein calculating controlling requirements for the systems and the pipelines of the project using information associated with the controlling case comprises recalculating structural requirements to support area and weight requirements associated with the controlling case.
